(19) United States
(12) Patent Application Publication
(10) Pub. No.: US 2007/0259745 A1
(43) Pub. Date: Nov. 8, 2007

(54) Centre of Rotation Support for an Assembly

(75) Inventors: Ralph Painta, Hagenbuechach (DE); Michael Bogner, Eckental (DE)

Correspondence Address: LUCAS & MERCANTI, LLP, 475 PARK AVENUE SOUTH, 15TH FLOOR, NEW YORK, NY, 10016, US

(73) Assignee: INA-SCHAEFFLER KG, Herzogenaurach (DE)

(21) Appl. No.: 11/574,162

(22) PCT Filed: Jul. 29, 2005
(86) PCT No.: PCT/EP05/08228

§ 371 Date: Feb. 23, 2007

(30) Foreign Application Priority Data
Aug. 25, 2004 (DE) 10 2004 041 044.5

(51) Int. Cl. F16H 7/08; F16C 19/00; F16H 7/14

(52) U.S. Cl. 474/117; 384/129; 384/91; 474/101

(57) ABSTRACT

The invention relates to a tension system for a traction mechanism, comprising an assembly (6) which is arranged pivotably via a pivot bearing (17a). In this case, the assembly at the same time assumes the function of a tension system for the traction means (2).

### FIELD OF THE INVENTION

The present invention relates to an assembly of an internal combustion engine, said assembly being designed at the same time as a tension system for a traction means of a traction mechanism. The assembly provided is preferably a generator or a starter generator. The housing of the assembly comprises holding means which, with at least one holder arranged at a fixed location, preferably on the internal combustion engine, form a rotary bearing.

### BACKGROUND OF THE INVENTION

A traction mechanism is preferably provided for driving various individual assemblies of the combustion engine, such as the water pump, air conditioning compressor and steering booster pump. For this purpose, a traction means, in particular a belt, connects the individual belt pulleys of the assemblies to be driven, the driving members, to the belt pulley of the driven member, a belt pulley preferably connected to the crankshaft of the internal combustion engine. The nonslip drive of all the assemblies to be driven requires a tension system, by means of which a sufficient, preferably nonslip pretensioning of the traction means can be ensured.

A tension system of this type is known, for example, from DE 43 00 178 C1, in which, in the installed state, a tension roller is supported under the action of force on the traction means. The tension system comprises, furthermore, a base part which is arranged at a fixed location and the axis of symmetry of which at the same time forms an axis of rotation for the pivoting arm on which a tension roller is arranged rotatably on the outside. To achieve a nonpositive support of the tension roller on the traction means, a torsion spring is inserted between the base part and the pivoting arm.

DE 100 57 818a A1 discloses a traction mechanism, designed as a two-pulley mechanism, of an internal combustion engine. The drive in this case takes place via a driven member which is connected rigidly in terms of rotation to a crankshaft of the internal combustion engine and which via a traction means, a belt, connects the further belt pulley, the driving member. For this purpose, the driving member provided is a starter generator which assumes the function of both the starter and the generator for the internal combustion engine. A sufficient pretensioning of the traction means to achieve a nonslip drive is achieved by means of the pivotably arranged driving member which is additionally acted upon with force by a spring means.

### OBJECT OF THE INVENTION

The object on which the present invention is based is to develop an assembly of an internal combustion engine, said assembly being designed at the same time as a tension system for a traction means of a traction mechanism, according to the features of the preamble of claim 1, in order to achieve a cost-optimized center of rotation support. Furthermore, the support is to be configured such that an optimal introduction of force into the center of rotation support is established.

This object is achieved, according to the invention, by means of the features of claim 1.

According to the invention, the housing of the pivotable assembly, which comprises, in particular, a starter generator, is designed in a divided way with two housing elements or housing halves which are joined together via a parting plane. The housing elements are in this case supported with respect to one another by a machined surface in the region of the parting plane. This ensures that a large-area support of the housing elements and therefore a distortion-resistant housing are obtained.

The housing of the assembly includes, furthermore, at least one fastening lug as holding means. Preferably, each housing element comprises a fastening lug, which fastening lugs together, in the installed state, that is to say in the completed state of the assembly or of the starter generator, are supported over a large area via a supporting surface and jointly form a holding means. The holding means, combined with a preferably axially offset holder which is connected, for example, directly to the internal combustion engine, forms a rotary bearing for the assembly.

As a result, advantageously, a support base made longer can be implemented for the assembly designed as a starter generator. Furthermore, forming the holding means on the housing makes it possible to have a high-mass tie-up of the assembly, with the result that the latter, in particular a starter generator, can be mounted so as to project freely. Along with this, there is the possibility of displacing the rotary bearing axially near to a line of force of the traction means from which the rotary bearing is acted upon with force. This arrangement reduces the tilting moment in the rotary bearing and, along with this, an adverse edge load or edge carrying force in the plain bearing, with the result that an increased useful life can be achieved. In summary, the rotary bearing according to the invention brings about a reinforced fastening or tie-up of the assembly to the internal combustion engine and, at the same time, an increased useful life.

Further advantageous embodiments of the invention are the subject matter of the dependent claims 2 to 13.

According to an advantageous embodiment of the invention, each housing element of the housing is assigned a fastening lug. Preferably, for this purpose, an aligned coincidence of the parting plane of the housing elements with the supporting surface of the associated holding means configured as fastening lugs is provided. Consequently, the surfaces to be machined lie in one plane, thus resulting in simplified machining. The smaller number of surfaces to be machined separately affords a cost benefit in terms of the housing.

This construction of the rotary bearing requires merely a separate machining of one end face of the holding means in the region of the contact surface via which the holding means is supported on the holder.

According to a further embodiment, to form the holding means, only one housing element or one housing half of the assembly has a fastening lug. The position and arrangement of the holding means are in this case such that the jointly machined end face, coinciding with the parting plane, of the fastening lug constitutes the contact surface with which the holding means, the fastening lug, is supported on the holder.

The concept according to the invention allows cost-optimized manufacture of the housing, since the machining of the housing halves in the region of the parting plane requires no subsequent machining of the supporting surfaces or of the contact surface of the holding means.

The parting plane of the housing of the assembly advantageously runs eccentrically such that it is arranged as near as possible in the direction of the belt pulley of the assembly. By the holding means being assigned to the wider housing element facing away from the belt pulley, a lever arm occurring between the introduction of force of the traction means and the rotary bearing can advantageously be reduced. The shortened lever arm effectively reduces the tilting moment and the edge load of the plain bearing associated with this.

Alternatively to this, the rotary bearing according to the invention can likewise be combined with an eccentrically divided housing, in which the housing element assigned to the traction means is made wider, as compared with the associated further housing element. Moreover, the invention includes a rotary bearing, in which the fastening lug or fastening lugs, the holding means, is or are arranged so as to be axially offset with respect to the parting line, that is to say the parting line of the housing elements is nbot aligned with the contact surface of the holding elements.

According to a preferred embodiment of the invention, the holder, which is connected indirectly or directly to the internal combustion engine, includes a rotatable bush which, in the installed state, is fixed in terms of rotation to the holding means of the pivotable assembly. There serves in this case as fastening means, in particular, a screw by means of which the components of the rotary bearing, the bush of the holder and the holder are braced.

For holding means which comprise two fastening lugs, it is appropriate to provide a fastening lug assigned to the holder with a through bore and to introduce into the further fastening lug a threaded bore in which the screw is screwed.

A further embodiment of the invention relates to the configuration of the holder which, according to the invention, is configured in a U-shaped carrier or as a fork. These components form two receptacles which are offset axially with respect to one another and between which the fastening lug or fastening lugs is or are inserted. A shaft or a fastening screw connects the receptacles and at the same time guides the holding means, and consequently the assembly is thereby positioned.

To achieve an unimpeded functioning of the rotary bearing in which the holding means cooperates with a holder having two receptacles, one receptacle is designed as a fixed bearing and the other receptacle as a loose bearing.

A selftapping or selfcutting screw, which alone, that is to say without a screw nut, makes it possible to have effective permanent connection and securing, is preferably suitable as fastening means.

Moreover, advantageously, it is appropriate to assign to the tension system according to the invention, represented by the assembly pivotable via, the rotary bearing, a separate bracket which is preferably fastened releasably to the internal combustion engine by means of a screw connection. The bracket in this case forms a holder which with holding means of the assembly forms the rotary bearing.

Optimal low-friction support of the assembly can advantageously take place via a plain bearing, by means of which the bush is inserted in the holder and connected rigidly in terms of rotation to the assembly. Alternatively, the invention likewise includes a reversed arrangement, in which the bush is rotatably assigned via a plain bearing to the holding means, for example the fastening lugs of the generator, and, on the other hand, is fixed in position with respect to the holder.

Moreover, the rotary bearing according to the invention can be coupled to a damping device, in order thereby to eliminate adverse resonances of the traction mechanism or to damp oscillations introduced into the traction mechanism on account of the rotational nonuniformity of the internal combustion engine. It is appropriate, as a damping device, for the rotary bearing to have a pretensioned design, in which a friction disk is arranged, for example, between the components of the rotary bearing which are rotatable in relation to one another.

A nonslip drive of the traction mechanism requires a sufficiently pretensioned traction means. Preferably, the pivotable assembly, which at the same time assumes the function of the tension system, is provided with a rotary bearing, the position of which makes it possible to utilize the dead weight of the pivotable assembly in order to influence the pretension of the traction means. A force means may additionally be provided for assistance, by which the assembly, the starter generator, is acted upon with force in the direction of rotation which pretensions the traction means.

### BRIEF DESCRIPTION OF THE DRAWINGS

The invention is explained in more detail below with reference to three exemplary embodiments depicted in a total of five figures in which:

FIG. 1 shows the construction of a rotary bearing of a tension system according to the invention;

FIG. 2 shows a further rotary bearing constructed according to the invention for a tension system;

FIG. 3 shows an enlarged illustration of a detail of the rotary bearing according to FIG. 2;

FIG. 4 shows a part region of an assembly which is designed pivotably as a tension system and in which the holding means is connected to only one housing element of the assembly;

FIG. 5 shows a basic illustration of a traction mechanism which includes a pivotable assembly as a tension system.

### DETAILED DESCRIPTION OF THE DRAWINGS

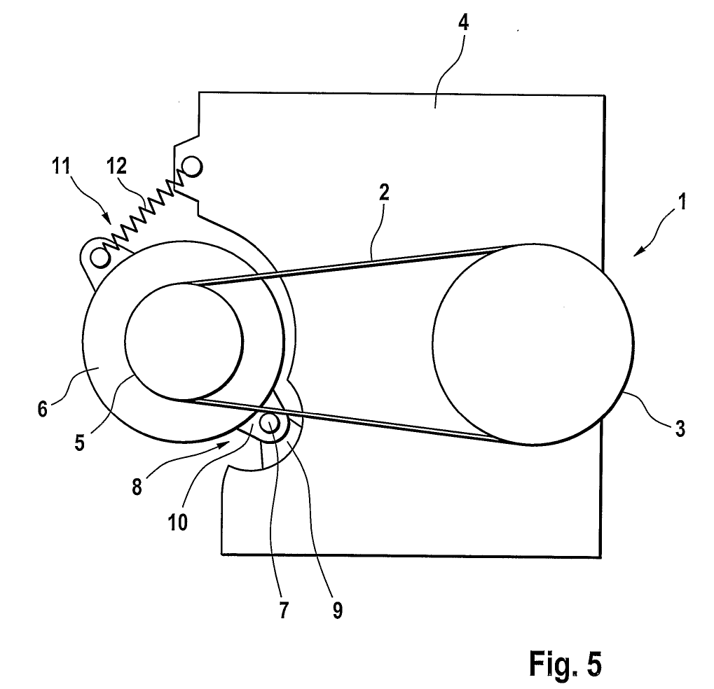

A known tension system for a traction mechanism is first explained with reference to FIG. 5, consisting of a pivotably arranged assembly. The traction mechanism 1 according to FIG. 5 is designed as a two-pulley mechanism, in which a traction means 2 connects a driven member 3, a belt pulley connected to a crankshaft of the internal combustion engine 4 and a further belt pulley of a driving member 5. The driving member 5 provided is a pivotably arranged assembly 6, in particular a starter generator, which for the internal combustion engine 4, as a function of the operating mode, assumes the function of the starter in the starting phase and the function of a generator when the internal combustion engine 4 is running.

To achieve a sufficient pretensioning of the traction means 2, the assembly 6 is pivotable about an axis of rotation 7 of the rotary bearing 8. The rotary bearing 8 comprises a holder 9 connected in one piece to the internal combustion engine 4, and also associated holding means 10 of the assembly 6. A counterclockwise pivoting of the assembly 6 increases the pretension of the traction means 2. The position of the rotary bearing 8 promotes the pretensioning of the traction means 2, since this, utilizing the weight of the assembly 6, exerts a force component acting counterclockwise. The assembly 6, which performs the function of a tension system 11, is provided with a force means 12, in particular a spring which is inserted between the internal combustion engine 4 and the assembly 6 and by means of which the pretension of the traction means 2 can be increased.

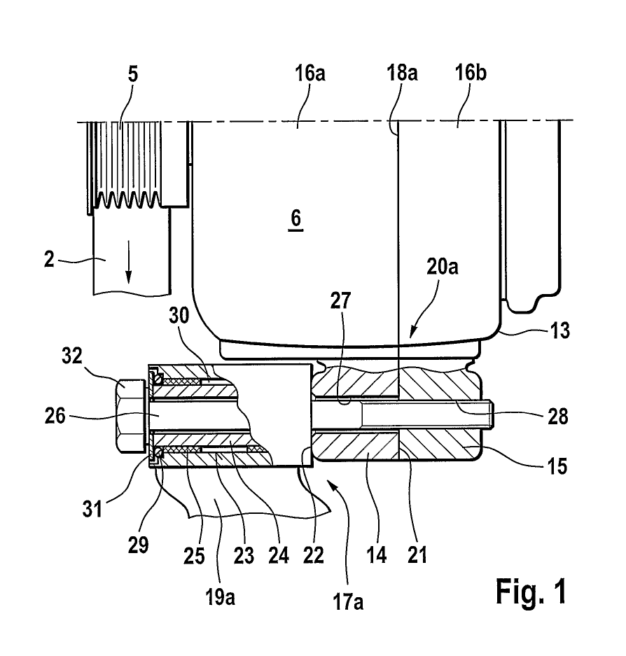

FIG. 1 shows a first rotary bearing 17a designed according to the invention, which comprises as holding means 20a fastening lugs 14, 15 connected in one piece to a housing 13 of the assembly 6, and also a holder 19a. The housing 13 of the assembly 6 is formed from the two housing elements 16a, 16b which are supported via a parting plane 18a. The parting plane 18a is continued beyond the region of the fastening lugs 14, 15, so that, by a machining of the respective housing element 16a, 16b, including the associated fastening lugs 14 and 15, at the same time a supporting surface 21 is machined, via which the fastening lugs 14, 15 are supported in the installation position.

Furthermore, the fastening lug 14 is directly supported with an end face facing away from the supporting surface 21 on an end face of the holder 19a, said end faces jointly forming a contact surface 22. The holder 19a connected directly or indirectly to the internal combustion engine 4 is provided with a through bore 23 into which a bush 24 is inserted. To achieve a relative movement or relative rotation of the bush 24 with respect to the holder 19a, a plain bearing 25 is inserted in an annular gap which is formed between the through bore 23 and a surface area of the bush 24. In the installation state, the bush 24 is supported nonpositively on the fastening lug 14 and consequently on the holding means 20a by a fastening means, a screw 26.

By virtue of this measure, in the operating state, an intended rotation of the bush 24 with respect to the holder 19a occurs, since the bush 24 is connected fixedly in terms of rotation to the holding means 20a and consequently to the assembly 6. The screw 26 is in this case first guided in a reception bore 27 of the fastening lug 14 and, furthermore, is screwed into a threaded bore 28 of the fastening lug 15. To seal off the plain bearing 25, a sealing ring 29 is provided, which seals off an annular gap 30 occurring between the holder 19a and the bush 24. The sealing ring 28 is covered on the end face by a disk 31 which is inserted between a screw head 32 and the bush 24. Advantageously, the configuration according to the invention of the rotary bearing 17a allows displacement in the direction of the traction means 2, with the result that the force direction introduced into the assembly 6 by the traction means 2 in the direction of the arrow triggers a reduced tilting moment in the rotary bearing 17a, this having an advantageous effect on the load exerted on the plain bearing 25, with the result that an increased useful life can be implemented.

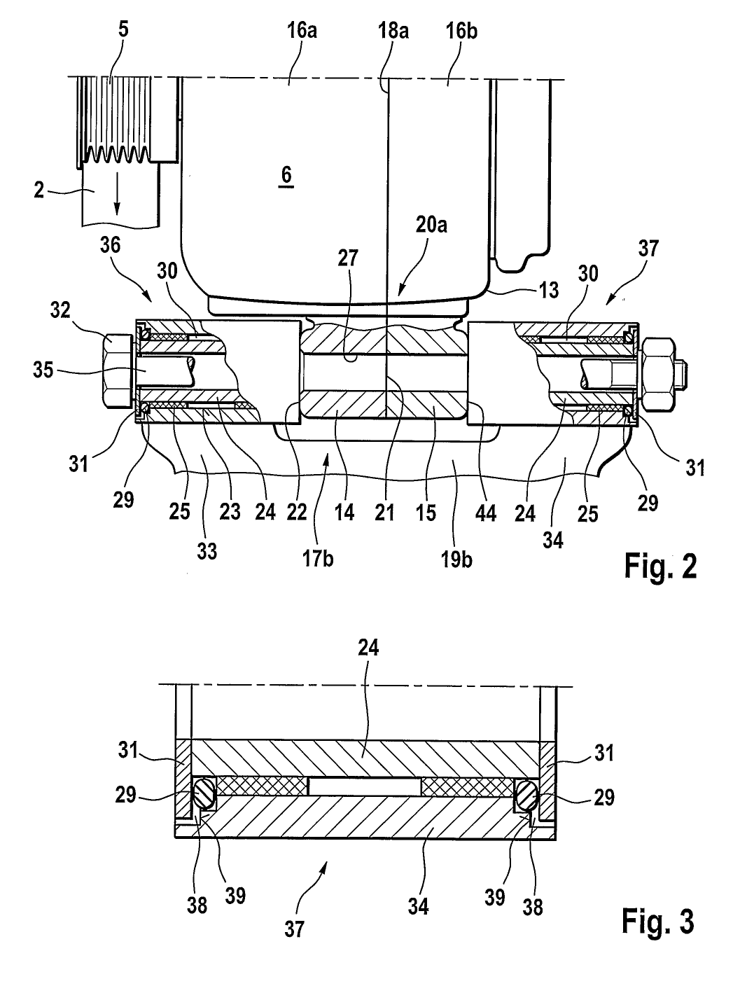

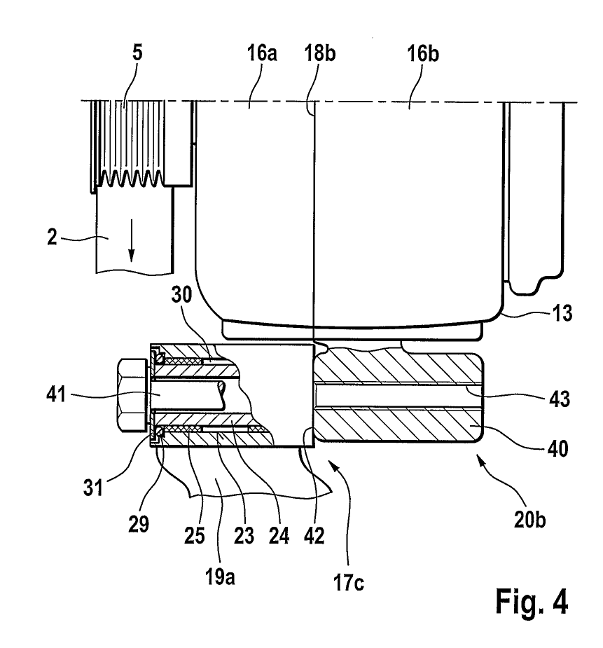

In the two further exemplary embodiments shown in FIGS. 2 and 4, the components identical to those of the first exemplary embodiment (FIG. 1) are given the same reference numerals, so that, to avoid repetition, reference may be made to the description of the first exemplary embodiment.

FIG. 2 shows the rotary bearing 17b which comprises a holder 19b of U-shaped configuration, for example a separate bracket which is fastened, on the one hand, releasably to the internal combustion engine 4 and comprises two receptacles 33, 34 spaced apart axially. The holding means 20a consisting of the fastening lugs 14, 15 is inserted between the receptacles 33, 34. The receptacles 33, 34, in conjunction with the bushes 24 inserted in them, according to the first exemplary embodiment, make it possible to have an arrangement free of play. In the installation state, the bushes 24 are pressed against the holding means 20a, the fastening lugs 14, 15, by means of the screw 35 via the contact surfaces 22, 44. This nonpositive connection ensures, during a pivoting movement of the assembly 6, that there is a relative movement of the bushes 24 in relation to the respective receptacle 33, 34, the receptacles comprising plain bearings 25 comparably to the exemplary embodiment according to FIG. 1. To achieve a low-friction type of action of the rotary bearing 17b, the latter includes a receptacle 33 designed as a fixed bearing 36 and a receptacle 34 designed as a loose bearing 37.

The construction of the loose bearing 37 is illustrated in FIG. 3. The receptacle 34, depicted on an enlarged scale, shows the loose bearing 37 in the installed state, in which the configuration of the bush 24 ensures a projection 38 with respect to an end-face contour 39 of the receptacle 34. The projection 38, providing installation play, effectively prevents the disk 31 from bearing against the contour 39 of the receptacle 24, with the result that the assembly 6 can pivot, unimpeded, in the operating state.

FIG. 4 shows an exemplary embodiment with the rotary bearing 17c, which comprises the holder 19a according to the exemplary embodiment from FIG. 1 and also the holding means 20b. Contrary to the exemplary embodiments described above, the assembly 6 according to FIG. 4 is provided with a parting plane 18b which is arranged so as to be offset in the direction of the traction means 2. Furthermore, this construction advantageously reduces a transverse force which is introduced into the rotary bearing 17c by the traction means 2 in the direction of the arrow, on account of a reduced distance between the traction means 2 and the rotary bearing 17c.

The holding means 20b comprises merely one fastening lug 40 which is connected to the housing element 16b and the contact surface 42 of which runs in alignment with the parting plane 18a. Advantageously, therefore, both the parting plane 18ab and the contact surface 42 can be machined cost-effectively in one operation. Owing to the relatively large width of the fastening lug 40, it is appropriate to use as fastening means a selftapping screw 41 which is screwed in a selfcutting manner into a partially prepared threaded bore 43 of the fastening lug 40, in order to achieve a positionally fixed support of the bush 24 against the fastening lug 40 via the contact surface 42.

### REFERENCE NUMERALS

1 Traction mechanism
2 Traction means
3 Driven member
4 Internal combustion engine
5 Driving member
6 Assembly
7 Axis of rotation
8 Rotary bearing
9 Holder
10 Holding means
11 Tension system
12 Force means
13 Housing
14 Fastening lug
15 Fastening lug
16a Housing element
16b Housing element
17a Rotary bearing
17b Rotary bearing
17c Rotary bearing
18a Parting plane
18b Parting plane
19a Holder
19b Holder
20a Holding means
20b Holding means
21 Supporting surface
22 Contact surface
23 Through bore
24 Bush
25 Plain bearing
26 Screw
27 Reception bore
28 Threaded bore
29 Sealing ring
30 Annular gap
31 Disk
32 Screw head
33 Receptacle
34 Receptacle
35 Screw
36 Fixed bearing
37 Fixed bearing
38 Projection
39 Contour
40 Fastening lug
41 Screw
42 Contact surface
43 Threaded bore
44 Contact surface

1. A tensioning system comprising: a housing having holding means which, with at least one holder arranged at a fixed location, form a rotary bearing wherein an assembly, the housing of which comprises two housing elements which are supported with respect to one another and which form a parting plane, at least one housing element including a holding element which is formed from a fastening lug connected in one piece to the housing element, the holding means being supported on a holder via a contact surface, in order to form the rotary bearing.

2. The tension system as claimed in claim 1, wherein each housing element is assigned a fastening lug, which fastening lugs jointly form the holding element, an aligned coincidence of position being established between the parting plane of the housing elements and a supporting surface, via which the fastening lugs are supported, with the result that a simultaneous machining of the parting plane and of the supporting surface is obtained.

3. The tension system as claimed in claim 1, wherein the assembly, in which a housing element comprises a fastening lug which, in the installation position, is supported on the holder via a contact surface, in order to form the rotary bearing, an aligned coincidence of position being established between the parting plane of the housing element and the contact surface, said coincidence allowing a simultaneous machining of the housing element in the region of the parting plane and of the contact surface.

4. The tension system as claimed in claim 1, wherein the parting plane of the housing runs eccentrically, with the result that housing elements of different widths are obtained.

5. The tension system as claimed in claim 1, wherein the holder including a rotatable bush, which at the same time is connected rigidly in terms of rotation to the holding means, and a fastening means connects components of the rotary bearing.

6. The tension system as claimed in claim 1, wherein the fastening lugs supported over a large area with respect to one another and forming the holding means, the fastening lug assigned directly to the holder includes a through bore or reception bore and the further fastening lug includes a threaded bore.

7. The tension system as claimed in claim 1, wherein fastening lugs being assigned to a holder configured as a U-shaped carrier or as a fork.

8. The tension system as claimed in claim 7, wherein the holder is configured as a fork or carrier comprising two receptacles which are spaced apart axially from one another and between which the fastening lugs are guided and the receptacle as a loose bearing (37).

9. The tension system as claimed in claim 1, wherein the rotary bearing comprises as fastening means a screw which is provided with a selftapping thread.

10. The tension system as claimed in claim 1, further comprising a bracket which is designed as a separate holder and which is fastened releasably to the internal combustion engine and includes receptacles between which fastening lugs of the assembly are inserted.

11. The tension system as claimed in claim 5, wherein the bush of the rotary bearing is mounted rotatably via at least one plain bearing.

12. The tension system as claimed in claim 1, wherein a force means acts upon the assembly directly or indirectly in order to achieve an increased pretensioning of the traction means.

13. The tension system as claimed in claim 1, wherein the rotary bearing being connected to a damping device which damps the actuating movements of the assembly.
